(19) United States
(12) Patent Application Publication
(10) Pub. No.: US 2005/0011227 A1
(43) Pub. Date: Jan. 20, 2005

(54) Method of preparation of lens

(75) Inventors: Hiroyuki Sakai, Tokyo (JP); Shinichiro Hirota, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/808,321

(22) Filed: Mar. 25, 2004

(30) Foreign Application Priority Data
Mar. 26, 2003 (JP) 2003-085350

(51) Int. Cl. C03B 5/26

(52) U.S. Cl. 65/29.21; 65/29.18

(57) ABSTRACT

Method of manufacturing a concave meniscus lens with good surface precision. The method of manufacturing a concave meniscus lens method comprises press molding a glass material in a heat-softened state with a pressing mold. The heated glass material is fed between the molding surfaces of the preheated upper and lower pressing molds and press molded, and the upper and lower pressing molds are cooled to obtain a temporary lens; and when an irregularity is produced on one of the surfaces of the temporary lens, the temperature of the glass material, the preheating temperature of the upper and/or lower molds, or the cooling rate of the upper and/or lower molds is corrected to obtain a corrected lens. When the press molding of the temporary lens is conducted by the first and second pressure applications and an irregularity is produced on one of the surfaces of the temporary lens, the load of the second pressure application is corrected to obtain a corrected lens. The correction is repeated until the irregularity of the corrected lens obtained falls within the permitted range.

### TECHNICAL FIELD

The present invention relates to a method of manufacturing precision lenses in which high-precision optical glass elements is obtained without post-processing such as grinding or polishing, and in particular, to a molding method suited to the molding of meniscus lenses.

### BACKGROUND ART

In the field of precision pressing, to which the present invention relates, a pressing mold that has been precision processed to a mirror surface of prescribed shape is used to press mold a heat-softened glass material, transferring the molding surface of the pressing mold to the glass material to mold an optical element of prescribed surface precision. However, the glass material to which the shape of the molding surface is transferred by press molding undergoes a contraction in volume during the subsequent cooling step continuing until separation from the mold, and deform due to the effects of physical forces exerted during the application of pressure and residual stress caused by cooling. When deformation occurs and the optical element obtained is distorted by an amount exceeding the tolerance level, it cannot deliver the desired optical performance.

In recent years, size reduction and improved performance in digital cameras and video cameras have necessitated the manufacturing of large quantities of high-precision aspherical lenses. The demand for concave meniscus lenses has been particularly great. However, precision press molding of such lenses is more difficult than that of biconvex lenses and the like. It is often difficult to determine pressing conditions yielding lenses with good surface precision, and it is highly difficult to mold lenses affording desired optical performance.

A method of pressing lenses of relatively large diameter and lenses having concave surfaces is described in Japanese Unexamined Patent Publication (KOKAI) Heisei No. 5-24857 (Reference 1), for example. In this method, the glass is softened by heating to a temperature permitting deformation, pressed, cooled, and then subjected to pressure again during cooling to prevent deterioration of surface precision during cooling.

In Japanese Unexamined Patent Publication (KOKAI) Heisei Nos. 6-72726 (Reference 2) and 8-337426 (Reference 3), the requisite surface precision is achieved by setting molding conditions under which a certain irregularity occurs, and employing a pressing mold that has been processed to a shape canceling out the irregularity.

However, when press molding concave meniscus lenses, the simple re-application of pressure during cooling described in Reference 1 often does not yield lenses with good surface precision. Further, in a case where a pressing mold is processed based on conditions producing irregularity, the processing of the mold in a manner canceling out irregularity is undesirably time-consuming and expensive, compromising production efficiency.

The fact that the deterioration of the surface precision of the glass lens in precision press molding methods is due to deformation during cooling following pressing has been elucidated in the above-cited references. However, it has not been known as to how to go about controlling deformation of the glass occurring during the period from press molding up to separation from the mold in order to obtain concave meniscus lenses with good surface precision by press molding. For example, as shown in FIG. 1, irregularity occurs as change in the radial direction of the radius of curvature of the molded lens (temporary lens shape) relative to the setting value (setting shape) of the lens, sometimes precluding the obtaining of a desired surface precision. As a result, the use of the means described in the above-cited references does not permit the obtaining of a concave meniscus lens with good surface precision in the anticipated manner.

The present invention, devised to solve the above-stated problems, has for its object to provide a method of manufacturing glass lenses, including concave meniscus lenses, having good surface precision by controlling the deterioration in surface precision produced during the period following press molding of the glass material in the mold up to separation of the molded article from the mold.

The present inventors conducted multifaceted research into the relation between molding conditions and lens surface precision in the course of press molding meniscus lenses. As a result, they discovered a correlation between a number of molding conditions and lens surface precision, with a particularly close correlation to symmetrical surface precision anomalies (irregularities) centered on the optical axis. They also discovered that by using this correlation, it was possible to suppress irregularities and manufacture lenses of controlled surface precision. The present invention was devised on that basis.

In the present invention, the term “irregularities” means, as stated above, “symmetrical surface precision anomalies centered on the optical axis.”

Specifically, it was discovered that five parameters:
(1) the temperature to which the glass material is heated;
(2) the temperature to which the pressing mold is heated;
(3) the difference in temperature between the upper and lower pressing molds;
(4) the difference in cooling rate between the upper and lower pressing molds; and
(5) the second pressure application load when pressure is applied at two or more stages (first pressure application, second pressure application) had a substantial effect as molding conditions which control irregularity, a form of lens surface precision.

Thermal contraction and the presence of stress are thought to be the decisive factors when a lens that has been press molded at high temperature deforms during cooling. In particular, in contrast to biconvex lenses and the like that undergo nearly isotonic contraction, concave meniscus lenses undergo complex thermal contraction due to their shape.

Based on this fact, the present inventors found that factors 1) to 3) below determine the irregularity of lenses following pressing:
1) the correlation between the temperature of the glass material and that of the pressing mold to which the glass material is supplied (particularly when heating the glass material outside the mold);
2) the cooling balance of the molded lens in vertical; and
3) how the load determining the molding shape is applied.

Various molding conditions relating to these factors were investigated. As a result, it was discovered that parameters (1) through (5) above were conditions controlling irregularity, which is one form of lens surface precision, and that by suitably controlling these conditions, it was possible to obtain lenses, even concave meniscus lenses, of high surface precision. The present invention was devised on that basis.

### DISCLOSURE OF THE INVENTION

The first mode of the present invention is:

a method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:

feeding a glass material that has been heated to a prescribed temperature between the molding surfaces of the preheated upper and lower pressing molds and press molding the glass material to obtain a temporary lens;

correcting the temperature of the glass material to lower than a prescribed temperature when an irregularity is produced where the radius of curvature of the peripheral portion of the first or second surface of the temporary lens obtained is smaller than the radius of curvature of the center portion thereof, and molding a corrected lens under the conditions applying the corrected temperature of the glass material;

correcting the temperature of the glass material to higher than a prescribed temperature when an irregularity is produced where the radius of curvature of the peripheral portion of the first or second surface of the temporary lens obtained is greater than the radius of curvature of the center portion thereof, and molding a corrected lens under the conditions applying the corrected temperature of the glass material;

subsequently molding the original lens under the conditions applying the corrected temperature of glass material when the irregularity of the corrected lens obtained falls within a permitted range; and

repeating the temperature correction of the glass material and molding of the corrected lens when the irregularity of the corrected lens obtained falls outside the permitted range until the irregularity of the corrected lens obtained falls within the permitted range.

The second mode of the preset invention is:

a method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:

feeding a glass material that has been heated to a prescribed temperature between the molding surfaces of the upper and lower pressing molds that have been preheated to a prescribed temperature and press molding the glass material to obtain a temporary lens;

correcting the preheating temperature of the upper and lower molds to lower than a prescribed temperature when an irregularity is produced where the radius of curvature of the peripheral portion of the first or second surface of the temporary lens obtained is smaller than the radius of curvature of the center portion thereof, and molding a corrected lens under the conditions applying the corrected pressing mold temperature;

correcting the preheating temperature of the upper and lower molds to higher than a prescribed temperature when an irregularity is produced where the radius of curvature of the peripheral portion of the first or second surface of the temporary lens obtained is greater than the radius of curvature of the center portion thereof, and molding a corrected lens under the conditions applying the corrected pressing mold temperature;

subsequently molding the original lens under the conditions applying the corrected pressing mold temperature when the irregularity of the corrected lens obtained falls within a permitted range; and

repeating correction of the pressing mold temperature and molding of the corrected lens when the irregularity of the corrected lens obtained falls outside the permitted range until the irregularity of the corrected lens obtained falls within the permitted range.

The third mode of the present invention is:

a method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:

feeding a heated glass material between the molding surfaces of the upper and lower pressing molds that have been preheated to prescribed temperatures and press molding the glass material to obtain a temporary lens;

correcting by lowering the preheating temperature of the mold forming the second surface, or correcting by raising the preheating temperature of the mold forming the first surface, when an irregularity is produced where the radius of curvature of the peripheral portion of the first or second surface of the temporary lens obtained is smaller than the radius of curvature of the center portion thereof, and molding a corrected lens under the conditions applying the corrected pressing mold temperature;

correcting by raising the preheating temperature of the mold forming the second surface, or correcting by lowering the preheating temperature of the mold forming the first surface, when an irregularity is produced where the radius of curvature of the peripheral portion of the first or second surface of the temporary lens obtained is greater than the radius of curvature of the center portion thereof, and molding a corrected lens under the condition applying the corrected pressing mold temperature;

subsequently molding the original lens under the condition applying the corrected pressing mold temperature when the irregularity of the corrected lens obtained falls within a permitted range; and

repeating the pressing mold temperature correction and molding of the corrected lens when the irregularity of the corrected lens obtained falls outside the permitted range until the irregularity of the corrected lens obtained falls within the permitted range.

The fourth mode of the present invention is:

a method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:

feeding a heated glass material between the molding surfaces of the preheated upper and lower pressing molds and cooling the upper and lower molds at prescribed cooling rates and press molding the glass material to obtain a temporary lens;

correcting by increasing the cooling rate of the mold forming the second surface or by decreasing the cooling rate of the mold forming the first surface when an irregularity is produced where the radius of curvature of the peripheral portion of the first or second surface of the temporary lens obtained is smaller than the radius of curvature of the center portion thereof, and molding a corrected lens under the condition applying the corrected cooling rate;

correcting by decreasing the cooling rate of the mold forming the second surface or by increasing the cooling rate of the mold forming the first surface when an irregularity is produced where the radius of curvature of the peripheral portion of the first or second surface of the temporary lens obtained is greater than the radius of curvature of the center portion thereof, and molding a corrected lens under the condition applying the corrected cooling rate;

subsequently molding the original lens under the condition applying the corrected cooling rate when the irregularity of the corrected lens obtained falls within a permitted range; and

repeating the correction of the cooling rate and molding of the corrected lens when the irregularity of the corrected lens obtained falls outside the permitted range until the irregularity of the corrected lens obtained falls within the permitted range.

The fifth mode of the present invention is:

a method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:

conducting press molding comprising feeding a heated glass material between the molding surfaces of the preheated upper and lower pressing molds and immediately applying pressure for a first time at a prescribed load, and once cooling has begun, applying pressure for a second time at a prescribed load smaller than that of the pressure application for the first time to obtain a temporary lens;

correcting by making the load of the second pressure application greater than the above prescribed load when an irregularity is produced where the radius of curvature of the peripheral portion of the first or second surface of the temporary lens obtained is smaller than the radius of curvature of the center portion thereof, and molding a corrected lens under the condition applying the corrected load;

correcting by making the load of the second pressure application smaller than the above prescribed load when an irregularity is produced where the radius of curvature of the peripheral portion of the first or second surface of the temporary lens obtained is greater than the radius of curvature of the center portion thereof, and molding a corrected lens under the condition applying the corrected load;

subsequently molding the original lens by applying the corrected load when the irregularity of the corrected lens obtained falls within a permitted range; and

repeating the load correction and molding of the corrected lens when the irregularity of the corrected lens obtained falls outside the permitted range until the irregularity of the corrected lens obtained falls within the permitted range.

In modes 1 to 5 of the present invention above, the presence of a spherical surface on the first surface of the concave meniscus lens and the determination of the irregularity of the first surface of the temporary lens obtained permit the correction of molding conditions.

Further, in modes 1 to 5 of the present invention, the first or second surface of the concave meniscus lens may be aspherical.

One or a combination of the corrections of the method of the present invention are conducted to suitably correct press molding conditions and correct irregularity of the lens. Thus, it is possible to obtain lenses with good surface precision (for example, with one or fewer fringes of irregularity). Further, it is possible to achieve optimal pressing conditions without extensive trial and error.

The correlation between the correction of the present invention and improvement in surface precision is particularly marked when molding concave meniscus lenses by anisothermal pressing. Accordingly, determining the irregularity in shape of the temporary lens that is molded and applying one or a combination of the correction conditions of the present invention make it possible to rapidly determine conditions for molding the desired lens. As a result, it is possible to produce with great efficiency lenses of highly difficult shapes.

### BRIEF DESCRIPTION OF THE FIGURES

FIG. 1 is a drawing descriptive of the relation between displacement in the actual curved surface of a lens relative to the designed curve surface in an aspherical lens.

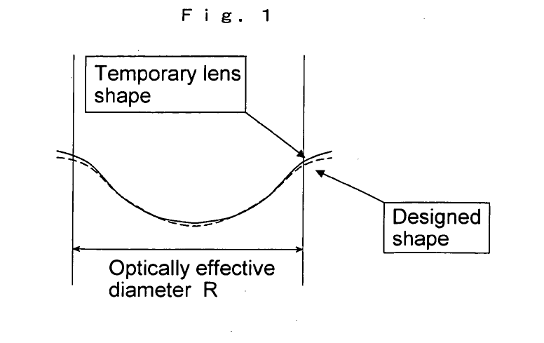

FIG. 2 is interference fringe photographs taken with a Fizeau interferometer showing change in lens irregularity due to change in glass material temperature.

FIG. 3 is interference fringe photographs taken with a Fizeau interferometer showing change in lens irregularity due to change in mold temperature.

FIG. 4 is interference fringe photographs taken with a Fizeau interferometer showing change in lens irregularity due to variation in a temperature difference between upper and lower molds and variation in these mold temperatures due to different cooling rates.

FIG. 5 is interference fringe photographs taken with a Fizeau interferometer showing change in lens irregularity due to change in the load of the second pressure application.

FIG. 6 shows typical types of irregularity.

### BEST MODE OF IMPLEMENTING THE INVENTION

All of the manufacturing methods of the present invention involve the press molding of a heat-softened glass material by a pair of molds in the form of an upper and lower mold having opposing molding surfaces to manufacture a concave meniscus lens having a first surface that is at least partially convex in shape and a second surface that is at least partially concave in shape. More specifically, as will be described further below, the manufacturing method of the present invention comprises the steps of (a) preheating, the pressing mold, (b) feeding the glass material, (c) press molding, (d) cooling and mold separation, and (e) removal. Each of steps (a) through (e) that are common to the five modes of the manufacturing method of the present invention will be described below. The manufacturing method of the present invention is not limited to molding steps such as those given below; however, the effect of the present invention is particularly marked in anisothermal pressing employing each of steps (a) through (e).

### Description of Steps

In the present invention, optical elements such as glass lenses are molded continuously by repeating molding steps such as those given below.

As is set forth further below, the manufacturing method of the present invention comprises the steps of manufacturing a temporary lens, corrected lens, and original lens (the originally targeted optical glass element). Although each of these manufacturing methods differs from the others, lenses are manufactured by conducting each of steps (a) through (e) below.

(a) Preheating the Pressing Molds

The upper and lower pressing molds are preheated to a prescribed temperature by a heating means such as a high-frequency induction coil. To cool the upper and lower pressing molds that have undergone a removal step (e) (described further below) in the previous cycle to a temperature suited to separation and removal of the lens from the mold, they are heated to a prescribed temperature suited to press molding in a preheating step. For example, the temperature to which the pressing molds are preheated desirably corresponds to a glass viscosity of 10⁸ to 10¹² dPaS. An excessively high mold temperature is problematic in that the glass fuses to the molding surfaces, and an excessively low temperature is problematic in that the glass material is damaged. Thus, the above-stated temperature range is desirable. The temperature setpoints of the upper and lower pressing molds may be identical or, in view of the shape, diameter, or the like of the lens being molded, may be different. When the temperature difference between the upper and lower pressing molds is excessively large, the difference in the amount of contraction between the upper and lower surfaces becomes excessive. Not only does this preclude effective correction of other parameters, but a difference in expansion between the upper and lower molds sometimes causes failure of the pressing operation. Thus, a difference of less than or equal to 60° C. is desirable when setting a temperature differential between the upper and lower pressing molds.

(b) Feeding the Glass Material

Conveyed glass material is fed between the preheated upper and lower pressing molds and positioned on the lower mold. A glass material (preform) of suitable weight that has been premolded to a prescribed shape is softened to a viscosity suited to molding and fed. Alternatively, a glass material at a temperature lower than the temperature corresponding to a viscosity suited to molding can be fed between the upper and lower molds and then heated to a viscosity suited to molding between the upper and lower molds. The effect of the present invention tends to be relatively marked when a glass material that has been softened in advance by heating to a temperature higher than the temperature established for molding is fed. The temperature of the glass material when fed to the pressing molds desirably corresponds to a viscosity of 10^{5.5} to 10¹² dPaS. At lower viscosities (higher temperatures) than this, contraction of the glass in the cooling step increases. Not only is it then impossible to obtain a molded glass article with good surface precision, but reaction between the glass material and the mold material sometimes results in fusion. Conversely, at high viscosities (lower temperatures) than this, deformation of the glass material by pressing becomes difficult, pressing to a prescribed thickness is precluded, and the glass and molds are sometimes damaged. The temperature of the glass material when fed to the pressing molds preferably corresponds to a viscosity of from 10^{5.5} to 10^{8.5} dPaS.

When the softened glass material contacts conveyor parts when being conveyed into position on the lower mold and defects are formed in the surface, the surface shape of the optical element that is molded is affected. Thus, the softened glass material is, for example, desirably conveyed while being floated on a gas and a jig is desirably employed to drop the glass material onto the molding surface of the lower mold.

(c) Press Molding

An optical element of prescribed surface shape is molded by keeping the upper and lower pressing molds and the glass material within their prescribed temperature ranges, applying pressure by raising the lower mold (or dropping the upper mold) with the glass material in a heat-softened state, and transferring the molding surfaces of the upper and lower pressing molds. The lower mold is raised by activating a driving means (for example, a servo motor) to raise the lower mold upward over a prescribed stroke and apply pressure to the glass material. When a glass material that has been softened by preheating is fed, pressure is applied immediately after feeding the glass material. The pressure-applying stroke of the lower mold is suitably determined based on the thickness of the optical element being molded and taking into account the thermal contraction of the glass during the cooling step. The pressure application schedule can be set as desired based on the shape and size of the optical element being molded.

When molding meniscus lenses by the present invention, multistage pressing in which the pressing schedule is divided into two or more stages and cooling is begun during pressure application yields good surface precision. For example, cooling may begin after the first application of pressure by means of a prescribed load immediately following feeding of the glass material between the upper and lower molds, or simultaneously with the first application of pressure. Subsequently, pressure may be applied a second time by means of a load smaller than that employed in the first application of pressure, or following the first application of pressure, the load may be temporarily reduced or released, the glass material cooled to a prescribed temperature, and pressure applied anew (a second pressure application).

The load applied in the first application of pressure is desirably from 30 to 300 Kg/cm² from the perspectives of glass viscosity and preventing destruction during deformation. The load applied in the second application of pressure is desirably smaller than that applied in the first application of pressure; for example, it can be about 10 to 80 percent that of the first application of pressure. The load in the second application of pressure is desirably from 20 to 150 Kg/cm². The use of these ranges is desirable in that it renders the second application of pressure highly effective and presents little possibility of damaging the glass.

For example, the first and second applications of pressure may be conducted in the following manner.

After feeding the glass material into the pressing molds, the pressing load is immediately applied as the first pressure application, greatly deforming the glass; however, the mold is stopped at a position where the glass material reaches a prescribed thickness. Cooling is begun either simultaneously with pressing or at the point in time where the glass material reaches a prescribed thickness, and the mold position is maintained until the temperature has dropped to a prescribed level. Thus, the load applied to the glass is essentially reduced. When a prescribed temperature is reached, the pressing load is again increased as the second pressure application.

(d) Cooling and Mold Separation

In addition to implementing a suitable pressure application schedule such as set forth above, the molded optical element and pressing mold are kept tightly together and cooled to a temperature corresponding to a glass viscosity of 10¹² dPaS, after which the press-molded article is separated from the mold. The mold separation temperature desirably corresponds to a viscosity of 10^{12.5} to 10^{13.5} dPaS.

The pressing mold cooling rate can be set to from 10 to 400° C./min, for example. An excessively low cooling rate lengthens the cooling time and decreases manufacturing efficiency. An excessively high cooling rate tends to result in deterioration of surface precision and produce flaws and cracks.

The upper and lower pressing molds can be cooled at different rates. The ratio of the cooling rates of the upper and lower pressing molds desirably falls within a range of from 1:4 to 4:1, for example. When the ratio of the cooling rates exceeds 4, the difference in temperature between the upper and lower surfaces during mold separation increases, causing large distortions to remain in the lens and presenting the possibility of damage following mold separation or during centering and edging. The cooling rate ratio between the upper and lower pressing molds is preferably from 1:1.5 to 1.5:1.

(e) Removal

After mold separation, the press molded article (optical element) on the molding surface of the lower mold can be automatically removed by a removal arm or the like equipped with a suction member, for example.

Methods of controlling surface precision characterizing the manufacturing method of the present invention will be described below.

(1) Controlling the Temperature to which the Glass Material is Heated (First Mode)

In the first mode of the manufacturing method of the present invention, a glass material that has been heated to a prescribed temperature is fed and press molded between the molding surfaces of preheated upper and lower pressing molds to obtain a temporary lens. The manufacturing of the temporary lens includes each of steps (a) to (e). When an irregularity is produced where the radius of curvature of the peripheral portion of the first surface or second surface of the temporary lens obtained is smaller than the radius of curvature of the center portion, the temperature of the glass material is corrected to lower than the above prescribed temperature, and the corrected glass material temperature is applied to mold a corrected lens.

As stated above, “irregularity” as referred to in the present invention means “symmetrical surface precision anomalies centered on the optical axis.” Thus, the above phrase “an irregularity is produced where the radius of curvature of the peripheral portion . . . is smaller than the radius of curvature of the center portion” means “a symmetrical surface precision anomaly centered on the optical axis where the radius of curvature of the center portion is smaller than the radius of curvature of the peripheral portion”.

In the present invention, the term “center portion” of the lens means the vicinity of the optical axis of the lens, and the term “peripheral portion” of the lens means, when r denotes the effective optical radius of the lens, the portion inside effective optical radius r but beyond r/3 from the center.

In the present invention, the radius of curvature of the center portion and that of the peripheral portion of the temporary lens are obtained as follows. First, the shapes of the spherical surface and aspherical surface of the temporary lens are measured. This measurement can be made with a tracing-type shape-measuring device.

The shape of the aspherical surface can be denoted by the following aspherical surface equation.
X=(Y\hat{ }2/R)/[1+{1−(1+K)(Y/R)\hat{ }2}\hat{ }0.5]+BY\hat{ }4+CY\hat{ }6+DY\hat{ }8+EY\hat{ }10

(This becomes a spherical surface when K=B=C=D=E=0).

Generally, each of the constants in the above equation can be established to specify an aspherical equation. When designing a lens, an aspherical surface equation is specified.

The value measured by the above shape-measuring device for the temporary lens is divided into the above-defined peripheral area and center area, and a best-fit aspherical surface equation, that is, an aspherical surface equation approximating the measured shape, is obtained. Here, the best-fit aspherical surface equation is obtained by calculating the paraxial radius of curvature (R0) that minimizes the difference with the measured shape (for example, the difference of values P−V) with only the R (paraxial radius of curvature) of the setting aspherical surface equation as a variable. The best-fit paraxial radius of curvature (R01) obtained for the center area in this manner is adopted as the radius of curvature of the center portion, and the best-fit paraxial radius of curvature (R02) obtained for the peripheral area is defined as the radius of curvature of the peripheral portion.

Here, when the center portion and peripheral portion have radii of curvature that are equal within the effective diameter, no irregularity has been produced. When there is a difference between the two, it appears as an irregularity. Accordingly, reducing the difference between the radii of curvature of the center and peripheral portions is synonymous with reducing the irregularity.

That is, in the present invention, the relation between the radius of curvature of the center portion and the radius of curvature of the peripheral portion thus obtained is examined, and molding conditions are corrected based on the magnitude of the relation.

In the present invention, when a certain relation exists between the radius of curvature of the peripheral portion and the radius of curvature of the center portion obtained by the above-described method from the shape of the temporary lens, that is, when a certain irregularity has been produced, it suffices to make the corrections in molding conditions specified in the various claims. In other words, the step of obtaining R01 or R02 by the above-described methods in the correction of the molding conditions is not mandatory in the present invention.

In the case of a spherical lens, the interference fringe with a reference spherical surface can be employed to readily detect irregularity and determine the relation between the radii of curvature of the center portion and the peripheral portion without using a tracing-type shape-measuring device such as that set forth above. That is, a Fizeau interferometer or the like can be used to compare the reading (radius of curvature) when the interference pattern of the lens center portion is rendered in the form of parallel straight lines to the reading (radius of curvature) when the interference fringe of the peripheral portion is rendered in the form of parallel straight lines.

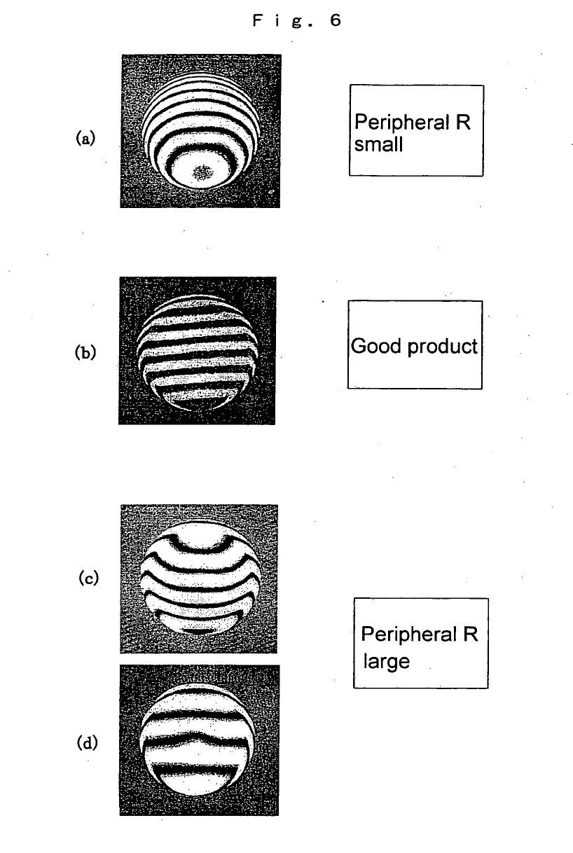

FIG. 6 shows the relation between the radii of curvature of the center portion and the peripheral portion and the relation thereof to irregularity observed in the interference fringe.

When an irregularity is produced where the radius of curvature of the first or second surface of the peripheral portion of the temporary lens obtained is greater than the radius of curvature of the center portion, a correction is made by increasing the temperature of the glass material to greater than the above-mentioned prescribed temperature, and a corrected lens is molded under the conditions applying the corrected glass material temperature.

The degree of correction of the temperature of the glass material can be suitably determined based on the degree of irregularity of the temporary lens. For example, the irregularity of the first surface of the temporary lens is determined and the temperature of the glass material is desirably corrected based on the level of irregularity.

When the irregularity of the corrected lens thus obtained falls within the permitted range, the original lens is subsequently molded under the conditions applying the corrected temperature of the glass material. However, when the irregularity of the second (or first) surface falls outside the permitted range, additional correction such as correction of the mold shape of the second surface can be made.

Whether or not the “irregularity falls within the permitted range” can be suitably determined based on the specifications of the concave meniscus lens being manufactured. For example, the phrase “the irregularity falls within the permitted range” can mean that the irregularity observed in the corrected lens is less than or equal to one newton using a Fizeau interferometer. The same applies in the description of the other modes of the present invention below.

In the case of an aspherical surface, the magnitude of the difference between the best-fit aspherical surface equation and the measured shape of the temporary lens (for example, the value of P−V) can be employed as the index of the size of the irregularity to set the permitted range.

When the irregularity of the corrected lens obtained falls outside the permitted range, correction of the temperature of the glass material and molding of the corrected lens can be repeated until irregularity of the corrected lens obtained falls within the permitted range. Once the irregularity of the corrected lens falls within the permitted range, the corrected temperature of the glass material is applied to mold the original lens.

In the present Specification, the term “original lens” refers to the optical glass element that is the object of manufacturing. After achieving conditions under which the original lens can be obtained by molding the temporary lens and the corrected lens, the original lens is continuously manufactured under those conditions.

The present inventors discovered that in the course of manufacturing a glass lens or the like in a press molding step, the temperature to which the glass material was set at the start of pressing correlated strongly to the surface precision of the molded optical element. The method of achieving conditions under which the original lens could be manufactured by molding a temporary lens and a corrected lens was based on this discovery.

For example, in a concave meniscus lens in which both the first and second surfaces are spherical, the radius of curvature of the effective diameter of both surfaces must be constant from the center of the lens to the peripheral portion. However, an irregularity is sometimes produced where the radius of curvature of the peripheral portion of a lens molded under temporary molding conditions is less than the radius of curvature near the center of the lens. The present inventors discovered that in such cases, a correction can be made by lowering the temperature to which the glass material is heated to obtain a lens having a uniform radius of curvature. Conversely, they also discovered that when an irregularity is produced where the radius of curvature of the peripheral portion of a temporary lens is greater than the radius of curvature in the vicinity of the center of the lens, a correction can be made by lowering the temperature to which the glass material is heated to obtain conditions for molding the original lens. The details are given in embodiments below.

The reason this effect is achieved is thought to be as follows. When the temperature of the glass material at the start of pressing is high, the volumetric contraction rate following pressing increases. In concave lenses in which the periphery is thicker than the vicinity of the center of the lens, the amount of contraction along the optical axis is greater in the peripheral portion than in the center of the lens. Thus, the pressure from the upper and lower molds is greater in the center portion than in the peripheral portion, leaving the peripheral portion relatively free to deform. The periphery of the lens is thought to deform by contracting toward the center, causing the radius of curvature of the peripheral portion to decrease.

(2) The Temperature to which the Pressing Molds are Heated (Second Mode)

In the second mode of the manufacturing method of the present invention, a heated glass material is fed and press molded between the molding surfaces of upper and lower pressing molds that have been preheated to a prescribed temperature, and a temporary lens is obtained. The temporary lens is manufactured by steps (a) through (e) set forth above. When irregularity is produced where the radius of curvature of the peripheral portion of the first or second surface of the temporary lens obtained is smaller than the radius of curvature of the center portion, a correction is made by lowering the temperature to which the upper and lower pressing molds are preheated below the above-stated prescribed temperature and a corrected lens is molded under the conditions applying the corrected pressing mold temperature. When irregularity is produced where the radius of curvature of the peripheral portion of the first or second surface of the temporary lens obtained is larger than the radius of curvature of the center portion, a correction is made by raising the temperature to which the upper and lower pressing molds are preheated above the above-stated prescribed temperature and a corrected lens is molded under the conditions applying the corrected pressing mold temperature.

The degree of correction of the temperature to which the upper and lower pressing molds are preheated can be suitably determined based on the degree of irregularity of the temporary lens. For example, it is desirable that the irregularity of the first surface of the temporary lens is determined and the temperature to which the upper and lower pressing molds are preheated is corrected based on the level of irregularity.

When the irregularity of the corrected lens thus obtained falls within the permitted range, the original lens is then molded under the conditions applying the corrected pressing mold temperature.

When the irregularity of the corrected lens obtained falls outside the permitted range, correction of the temperature of the pressing mold and the molding of corrected lenses are repeated until the irregularity of the corrected lens obtained falls within the permitted range. Once the irregularity of the corrected lens falls within the permitted range, the original lens is then molded under the conditions applying the corrected press molding temperature.

In concave meniscus lenses having spherical first and second surfaces, the present inventors discovered that when an irregularity is generated where the radius of curvature of the peripheral portion of the spherical lens molded under temporary molding conditions is smaller than the radius of curvature in the vicinity of the center of the lens, a correction can be made by decreasing the temperature to which the upper and lower molds are preheated to achieve conditions under which an original lens having a uniform radius of curvature can be molded. Conversely, they also discovered that when an irregularity is generated where the radius of curvature of the peripheral portion of the temporary lens is larger than in the vicinity of the center, it suffices to make a correction by increasing the temperature of the molds. This will be described in detail in embodiments further below. Such correction is thought to be possible because, similar to (1) above, the amount of contraction increases as the temperature of the glass material increases.

(3) Difference in the Temperature of the Upper and Lower Pressing Molds (Mode 3)

In the third mode of the manufacturing method of the present invention, the heated glass material is fed and press molded between the molding surfaces of upper and lower pressing molds that have each been preheated to prescribed temperatures, yielding a temporary lens. The temporary lens is manufactured by steps (a) through (e) above. When an irregularity is produced where the radius of curvature of the peripheral portion of the first or second surface of the temporary lens obtained is smaller than the radius of curvature of the center portion, a correction is made by lowering the temperature to which the mold pressing the second surface is heated or raising the temperature to which the mold pressing the first surface is preheated and a corrected lens is molded under the conditions applying the corrected pressing mold temperature. When an irregularity is produced where the radius of curvature of the peripheral portion of the first or second surface of the temporary lens obtained is larger than the radius of curvature of the center portion, a correction is made by raising the temperature to which the mold pressing the second surface is heated or lowering the temperature to which the mold pressing the first surface is preheated and a corrected lens is molded under the conditions applying the corrected pressing mold temperature.

The degree of correction of the pressing mold temperature can be suitably determined based on the degree of the irregularity of the temporary lens. For example, the irregularity in the first surface of the temporary lens can be determined and the pressing mold temperature can be corrected based on the level of irregularity.

When the irregularity of the corrected lens thus obtained falls within the permitted range, the original lens is then molded under the conditions applying the corrected pressing mold temperature.

Conversely, when the irregularity of the corrected lens obtains falls outside the permitted range, correction of the temperature of the pressing mold and molding of a corrected lens are repeated until the irregularity of the corrected lens obtained falls within the permitted range, after which the original lens is molded under the conditions applying the corrected pressing mold temperature.

The present inventors discovered that in concave meniscus lenses having spherical first and second surfaces, when an irregularity is produced where the radius of curvature of the peripheral portion of a lens molded under temporary pressing conditions is smaller than the radius of curvature in the vicinity of the center, a correction can be made either by lowering the temperature to which the mold pressing the second surface is preheated or by raising the temperature to which the mold pressing the first surface is preheated, and the original lens can be molded with good surface precision under the conditions applying the corrected pressing mold temperature. They also discovered that when an irregularity is produced where the radius of curvature of the peripheral portion of the temporary lens is larger than in the vicinity of the center, it suffices to make the reverse corrections. This is described in detail in embodiments below.

The glass cools rapidly, contraction occurs early, and fluidity is lost on the side where the temperature is relatively low. Thus, when setting the temperatures of the upper and lower molds, if the temperature of the lower mold is set low, for example, the lower surface of the glass (that is, the protruding surface) will lose fluidity first, after which contraction of the upper surface will occur. When that happens, upward tensile stress is thought to be generated in the peripheral portion of the lower surface, and the radius of curvature of the peripheral portion is thought to decrease.

(4) The Difference in Cooling Rate between the Upper and Lower Pressing Molds (Fourth Mode)

In the fourth mode of the present invention, a heated glass material is fed and press molded between the molding surfaces of preheated upper and lower pressing molds and the upper and lower molds are each cooled at prescribed rates to obtain a temporary lens. The temporary lens is manufactured by above-described steps (a) through (e).

When irregularity is produced where the radius of curvature of the peripheral portion of the first or second surface of the temporary lens is smaller than the radius of curvature of the center portion, correction -is made by increasing the cooling rate of the mold pressing the second surface or by decreasing the cooling rate of the mold pressing the first surface, and a corrected lens is molded under the conditions applying the corrected cooling rate. The cooling rate of the upper mold and that of the lower mold may be simultaneously corrected.

When irregularity is produced where the radius of curvature of the peripheral portion of the first or second surface of the temporary lens is larger than the radius of curvature of the center portion, correction is made by reducing the cooling rate of the mold pressing the second surface or by increasing the cooling rate of the mold pressing the first surface, and a corrected lens is molded under the conditions applying the corrected cooling rate. In this case, as well, the cooling rate of the mold pressing the second surface and that of the mold pressing the first surface may be simultaneously corrected.

The degree of correction of the cooling rate may be suitably determined based on the degree of irregularity in the temporary lens. For example, it is possible to correct the cooling rate based on the level of irregularity by determining the irregularity in the first surface of the temporary lens.

When the irregularity of the corrected lens thus obtained falls within the permitted range, the original lens is then molded under the conditions applying the corrected cooling rate.

Conversely, when the irregularity of the corrected lens obtained falls outside the permitted range, correction of the cooling rate and molding of a corrected lens are repeated until the irregularity of the corrected lens obtained falls within the permitted range. Once the irregularity of the corrected lens falls within the permitted range, the original lens is molded under the conditions applying the corrected cooling rate.

The present inventors discovered that in concave meniscus lenses having first and second spherical surfaces, when an irregularity is produced where the radius of curvature of the peripheral portion of a lens molded under temporary conditions is smaller than the radius of curvature in the vicinity of the center of the lens, it is possible to make a correction either by increasing the cooling rate of the mold pressing the second surface or by decreasing the cooling rate of the mold pressing the first surface and mold good original lenses. They also discovered that when an irregularity is produced where the radius of curvature of the peripheral portion of the temporary lens is greater than that in the vicinity of the center, the reverse correction is sufficient. This is specifically described in embodiments further below.

For example, it is thought that when the cooling rate of the lower mold is increased, the glass on the lower side solidifies first, and tensile stress is produced in the peripheral portion by contraction on the upper mold side, shifting the radius of curvature of the peripheral portion downward and permitting correction of the radius of curvature.

(5) Application of a Second Pressure Load when Applying Pressure in Two Stages (First Application of Pressure, Second Application of Pressure) (Mode 5)

In mode 5 of the manufacturing method of the present invention, press molding is conducted in which a heated glass material is fed between the molding surfaces of preheated upper and lower pressing molds, immediately a first pressure application is conducted by applying a prescribed load, and after cooling has begun, a second pressure application is conducted by applying a prescribed load smaller than that applied the first time to obtain a temporary lens. The temporary lens is manufactured by steps (a) through (e) above.

When an irregularity is generated where the radius of curvature of the peripheral portion of the first or second surface of the temporary lens is smaller than the radius of curvature of the center portion, correction is made by increasing the load of the second pressure application relative to the above prescribed load and a corrected lens is molded under the conditions applying the corrected load. When an irregularity is produced where the radius of curvature of the peripheral portion of the first or second surface of the temporary lens obtained is larger than the radius of curvature of the center portion, correction is made by reducing the load of the second pressure application relative to the above prescribed load and a corrected lens is molded under the conditions applying the corrected load.

The degree of correction of the load of the second pressure application is suitably determined based on the degree of the irregularity of the temporary lens. For example, it is possible to correct the load of the second pressure application based on the level of irregularity by determining the irregularity in the first surface of the temporary lens.

Correction can also be made by simply correcting the load of the second pressure application while keeping the period of load application constant (unchanged).

When the irregularity of the corrected lens obtained falls within the permitted range, the original lens is molded under the conditions applying the corrected load of the second pressure application. When the irregularity of the corrected lens obtained falls outside the permitted range, load correction and molding of a corrected lens are repeated until the irregularity of the corrected lens obtained falls within the permitted range. Once the irregularity of the corrected lens falls within the permitted range, the original lens is molded under the conditions applying the corrected load.

The present inventors discovered that in concave meniscus lenses having first and second spherical surfaces, when molding is conducted with two stages of pressing as set forth above (that is, in press molding comprising the feeding of a heated glass material between the molding surfaces of preheated upper and lower molds, immediately subjecting the heated glass material to a first pressure application in the form of a prescribed load, maintaining the mold position as cooling is begun to essentially reduce the pressure, and then conducting a second pressure application in the form of a prescribed load smaller than in the first pressure application), when an irregularity is generated where the radius of curvature of the peripheral portion of the temporary lens is smaller than the radius of curvature in the vicinity of the center of the lens, correction can be made by increasing the load in the second pressure application relative to the prescribed load and the original lens is molded under the conditions applying the corrected load. They also discovered that when an irregularity is produced where the radius of curvature of the peripheral portion of the lens is larger than in the vicinity of the center of the lens, it suffices to make a correction that is the reverse of the above. This is described in detail in embodiments set forth below.

Following the first pressure application, applying of pressure for a second time once the temperature has dropped by a prescribed amount has the effect of correcting the change (camber) of the lens following pressing. In particular, the applying of pressure for a second time before cooling to the Tg, where the modulus of thermal expansion of the glass drops precipitously, is highly effective in improving the surface precision of the lens. The smaller the load employed in the second pressure application, the less pronounced the effect and the smaller the radius of curvature of the peripheral portion of the lens. Thus, increasing the load causes this radius of curvature to shift upward.

Examples of lens where the first and second surfaces are spherical surfaces have been described above. However, the manufacturing method of the present invention can be applied to obtain original lenses (optical glass elements) even in the case of lenses in which one or both of the first and second surfaces are aspherical surfaces since the tendency is the same in the aspherical lenses.

In a lens in which one or both of the first and second surfaces are aspherical surfaces, for example, the shape of the temporary lens can be determined with a tracing-type shape-measuring device, and based on the shape, a correction method can be obtained by referring the design shape. A correction method can also be obtained based on measurement results obtained with a shape-measuring device for spherical lenses.

That is, in the same manner as described in (1), it is possible to determine a prescribed relation between the radii of curvature of the center portion and peripheral portion of an aspherical lens in modes (2) through (5). That is, for an aspherical lens, best-fit aspherical surface equations having a paraxial radius of curvature (R0) minimizing the difference between the aspherical surface shape and the shape of the temporary lens (or corrected lens) (for example, the value of P−V) based on the aspherical surface equation with the paraxial radius of curvature (R) as the only variable in the design aspherical surface, are calculated for the center portion and the peripheral portion. The R01 obtained for the center portion is made the radius of curvature of the center portion and the R02 obtained for the peripheral portion is made the radius of curvature of the peripheral portion. The center portion and the peripheral portion can then be compared by a means identical to that employed for spherical surface lenses to correct for irregularity.

As required, optimal pressing conditions can be determined by repeating the method of the present invention. Press molding conditions can be suitably corrected and lens irregularity can be corrected using a combination of two or more of the conditions disclosed in modes 1 to 5 of the manufacturing method of the present invention. Specifically, the manufacturing method of the present invention permits the molding of lenses having not more than one fringe of irregularity.

When both the first and second surfaces of a desired lens being molded are spherical surfaces, irregularity of either surface can be determined by obtaining an interference fringe with a Fizeau interferometer and pressing conditions can be corrected on that basis. For aspherical surfaces, the surface shape can be determined with a tracing-type shape-measuring device such as that set forth above. In lenses having one spherical surface and one aspherical surface, the irregularity is desirably determined and molding conditions reflecting correction of the irregularity are desirably calculated on the spherical surface side. This is because, although it is also possible to determine and correct for irregularity on the aspherical surface side, it becomes necessary to change the spherical surface side to an aspherical surface by mold correction when the irregularity on the spherical side deteriorates during this process.

When applying the present invention, either the first or the second surface can be used to determine the irregularity. However, this determination is desirably made based on the first surface (protruding surface side) because the radius of curvature is larger than on the concave surface, permitting more prominent observation of irregularity.

In concave meniscus lenses having a spherical surface on the first side, the irregularity on the first side of the temporary lens obtained is desirably determined to correct molding conditions.

[Embodiments]

The present invention is described in greater detail below based on embodiments.

[Embodiment 1] (Change in Irregularity Due to Glass Material Temperature)

A concave meniscus lens having spherical first and second surfaces, a diameter of 11 mm, and a center thickness of 1.2 mm was molded. A phosphate glass material (Tg: 450° C., Ts: 490° C.) was preshaped into oblate spherical preforms 10mm in diameter and 420 mm³ in volume. These preforms were heated to various temperatures (510 to 550° C.) yielding viscosities of from 10⁷ to 10⁹ dPaS. They were then fed between upper and lower molds that had been heated to a temperature (510° C.) corresponding to a glass viscosity of 10⁹ dPaS and a temperature (490° C.) corresponding to a glass viscosity of 10¹⁰ dPaS, and the lower mold was immediately raised to press the preform between the upper and lower molds. The initial pressure during pressing was 150 Kg/cm², and cooling (both upper and lower molds were cooled at a rate of 100° C./min) was begun immediately following the start of pressing. At a position where a pressure displacement of about 100 micrometers remained, the lower mold was stopped and maintained in place, essentially reducing the load on the glass. When the temperature had dropped to 15° C. above Tg, pressure was applied for a second time. Mold separation was conducted at 20° C. below Tg. The second pressure application was 80 Kg/cm².

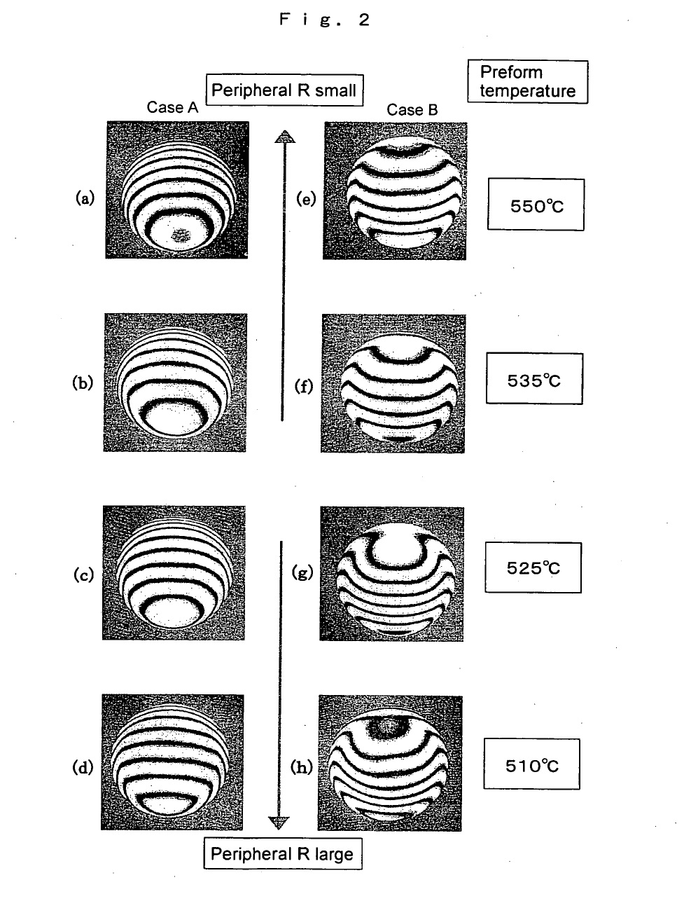

FIG. 2 shows the results of &valuation with an interferometer of the spherical shapes (protruding surface side) of lenses obtained at various temperatures. These results reveal that a high preform temperature resulted in a surface shape with a radius of curvature in the peripheral portion that was smaller than that in the center portion. Conversely, as the temperature decreased, the radius of curvature of the peripheral portion increased.

In FIG. 2, in Case A (mold temperature: 510° C.), lens surface precision improved as the preheating temperature of the preform decreased. In Case B (mold temperature: 470° C.), lens surface precision improved as the preheating temperature of the preform increased. FIG. 6 shows an interferometric photograph of a typical type of irregularity and the relation of the size of the radius of curvature of the peripheral portion to that of the center portion for reference.

[Embodiment 2] (Changes in Irregularity Due to Mold Temperature)

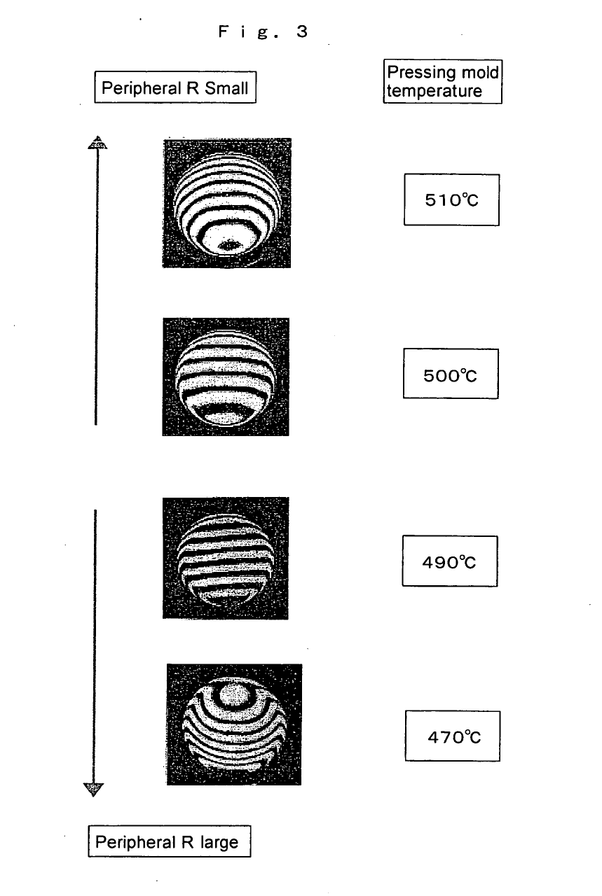

The same preform and pressing mold were employed as in Embodiment 1. The preform was heated to a temperature (550° C.) at which the glass viscosity was 10⁷ dPaS and then fed onto a lower mold that had been heated to a temperature (470 to 510° C.) corresponding to a glass viscosity of 10⁹ to 10¹¹ dPaS. The lower mold was immediately raised to press the preform between the upper and lower molds. The pressing pressure and schedule were identical to those in Embodiment 1. An identical temperature was employed for the upper and lower molds. The cooling rate was 100° C./min for both the upper and lower molds and the second pressure application was conducted at 460° C. As shown in FIG. 3, when the mold temperature was high, the surface shape was such that the radius of curvature of the peripheral portion was smaller than that of the center portion, and conversely, as the temperature decreased, the radius of curvature of the peripheral portion increased.

[Embodiment 3] (Changes in Irregularity Due to a Difference in Temperature between the Upper and Lower Molds and a Difference in Cooling Rate)

The same preform and pressing mold were employed as in Embodiment 1. The preform was heated to a temperature (550° C.) corresponding to a glass viscosity of 10⁷ dPaS and then fed into the lower mold (the mold pressing the first surface) that had been heated to a temperature (490 to 505° C.) corresponding to a glass viscosity of 10⁹ to 10¹¹ dPaS. The lower mold was immediately raised to press the preform against an upper mold (the mold pressing the second surface) that had been heated to 490° C. The pressing schedule was identical to that in Embodiment 1. However, a cooling rate following pressing of 80° C./min was employed for the upper mold and 75 to 105° C./min for the lower mold.

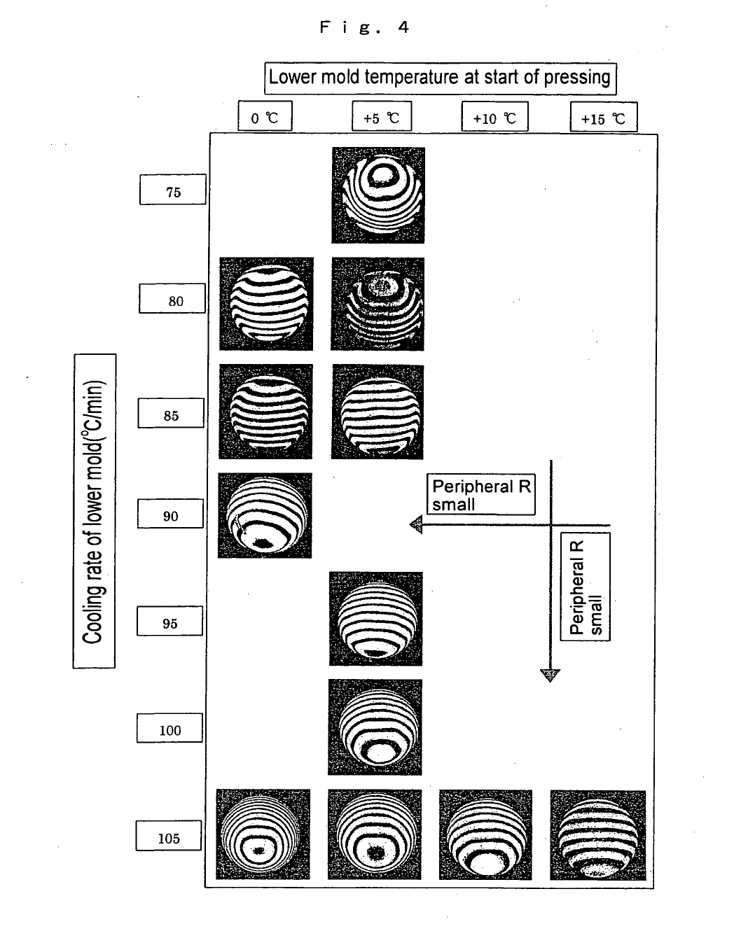

As shown in FIG. 4, when the lower mold temperature at the start of pressing was made lower than that of the upper mold, the surface shape was such that the radius of curvature of the peripheral portion was smaller than that of the center portion. Conversely, as the temperature increased, the radius of curvature of the peripheral portion tended to increase. Further, when the cooling rate of the lower mold was decreased, the surface shape was such that the radius of curvature of the peripheral portion was larger than that of the center portion. Conversely, as the cooling rate increased, the radius of curvature of the peripheral portion tended to decrease.

When two parameters were varied, not just one condition yielding good surfaces, but many combinations of conditions yielding good surfaces were achieved.

When the temperature and cooling rate of the lower mold were fixed and the temperature and cooling rate of the upper mold were varied, a decrease in the upper mold temperature resulted in a surface shape where the radius of curvature of the peripheral portion was larger than that of the center portion. Conversely, as the temperature was decreased, the radius of curvature of the peripheral portion tended to decrease. When the cooling rate of the upper mold was decreased, the surface shape was such that the radius of curvature of the peripheral portion was smaller than that of the center portion. Conversely, as the cooling temperature increased, the radius of curvature of the peripheral portion tended to increase.

[Embodiment 4] (Change in Irregularity Due to the Second Pressure Application Load)

The same preform and pressing mold were employed as in Embodiment 1. The preform was heated to a temperature (550° C.) at which the glass viscosity was 10⁷ dPaS and then fed into a lower mold (the mold pressing the first surface) that had been heated to a temperature (490° C.) corresponding to a glass viscosity of 10¹⁰ dPaS. The lower mold was immediately raised to press the preform against an upper mold (the mold pressing the second surface) that had been heated to 495° C. The second pressure application was conducted at the load shown in FIG. 4 at 470° C.

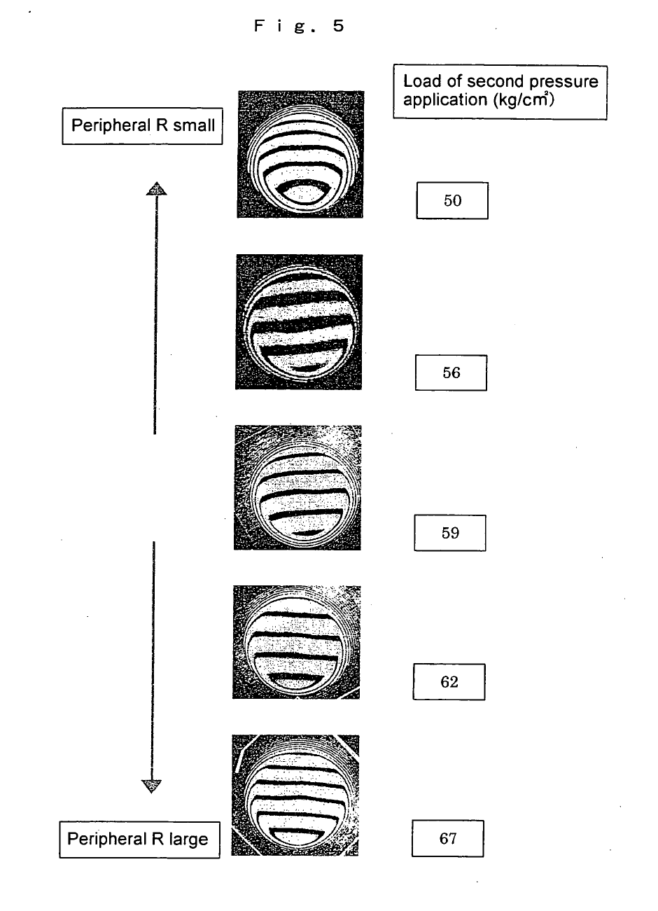

As shown in FIG. 5, as the load of the second pressure application increased, the surface shape was such that the radius of curvature of the peripheral portion tended to become larger than that of the center portion. Further, as the load of the second pressure application decreased, the radius of curvature of the peripheral portion tended to decrease.

[Embodiment 5]

A barium borosilicate glass material (Tg: 514° C., Ts: 545° C.) was heated to 615° C., fed by dropping onto a lower mold (a spherical mold forming the first surface) that had been preheated to 590° C., and press molded between the lower mold and an upper mold (an aspherical mold forming the second surface) that had been heated to the same temperature. Cooling was begun simultaneously with pressing. Pressure was applied a second time at 540° C. Pressing was halted at 495° C. and the lens was recovered. In this process, the cooling rates of the upper and lower molds were varied. The paraxial radii of curvature of the center portion and peripheral portion of the second surface of the lens thus obtained were calculated by a best fit; the results obtained for irregularity of the aspherical surface are given in Table 1. The irregularity of the second surface due to acceleration of the cooling rate of the lower mold was such that the radius of curvature of the peripheral portion became relatively small. Accelerating the cooling rate of the upper mold was confirmed to increase the radius of curvature of the peripheral portion.

A decrease in irregularity was confirmed as the difference in R of the center portion and peripheral portion decreased based on the value of P−V when best-fitting was conducted for the entire effective diameter area.

TABLE 1

| | | | | |
|---|---|---|---|---|
| Mold cooling rate | Upper mold | 100 | 100 | 120 |
| ° C./min | Lower mold | 120 | 100 | 100 |
| Best-fit paraxial | Center portion | 6.89 | 6.92 | 6.94 |
| radius of curvature | [R01] | | | |
| (mm) | Peripheral portion | 6.88 | 6.89 | 6.87 |
| | [R02] | | | |

| | | | |
|---|---|---|---|
| Best-fit P − V value (entire effective | 0.09 | 0.27 | 0.39 |
| diameter area) (micrometer) | | | |

1. A method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:
feeding a glass material that has been heated to a prescribed temperature between the molding surfaces of the preheated upper and lower pressing molds and press molding the glass material to obtain a temporary lens;
correcting the temperature of the glass material to lower than a prescribed temperature when an irregularity is produced where the radius of curvature of the peripheral portion of the first or second surface of the temporary lens obtained is smaller than the radius of curvature of the center portion thereof, and molding a corrected lens under the conditions applying the corrected temperature of the glass material;
correcting the temperature of the glass material to higher than a prescribed temperature when an irregularity is produced where the radius of curvature of the peripheral portion of the first or second surface of the temporary lens obtained is greater than the radius of curvature of the center portion thereof, and molding a corrected lens under the conditions applying the corrected temperature of the glass material;
subsequently molding the original lens under the conditions applying the corrected temperature of glass material when the irregularity of the corrected lens obtained falls within a permitted range; and
repeating the temperature correction of the glass material and molding of the corrected lens when the irregularity of the corrected lens obtained falls outside the permitted range until the irregularity of the corrected lens obtained falls within the permitted range.

2. A method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:
feeding a glass material that has been heated to a prescribed temperature between the molding surfaces of the upper and lower pressing molds that have been preheated to a prescribed temperature and press molding the glass material to obtain a temporary lens;
correcting the preheating temperature of the upper and lower molds to lower than a prescribed temperature when an irregularity is produced where the radius of curvature of the peripheral portion of the first or second surface of the temporary lens obtained is smaller than the radius of curvature of the center portion thereof, and molding a corrected lens under the conditions applying the corrected pressing mold temperature;
correcting the preheating temperature of the upper and lower molds to higher than a prescribed temperature when an irregularity is produced where the radius of curvature of the peripheral portion of the first or second surface of the temporary lens obtained is greater than the radius of curvature of the center portion thereof, and molding a corrected lens under the conditions applying the corrected pressing mold temperature;
subsequently molding the original lens under the conditions applying the corrected pressing mold temperature when the irregularity of the corrected lens obtained falls within a permitted range; and
repeating correction of the pressing mold temperature and molding of the corrected lens when the irregularity of the corrected lens obtained falls outside the permitted range until the irregularity of the corrected lens obtained falls within the permitted range.

3. A method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:
feeding a heated glass material between the molding surfaces of the upper and lower pressing molds that have been preheated to prescribed temperatures and press molding the glass material to obtain a temporary lens;
correcting by lowering the preheating temperature of the mold forming the second surface, or correcting by raising the preheating temperature of the mold forming the first surface, when an irregularity is produced where the radius of curvature of the peripheral portion of the first or second surface of the temporary lens obtained is smaller than the radius of curvature of the center portion thereof, and molding a corrected lens under the conditions applying the corrected pressing mold temperature;
correcting by raising the preheating temperature of the mold forming the second surface, or correcting by lowering the preheating temperature of the mold forming the first surface, when an irregularity is produced where the radius of curvature of the peripheral portion of the first or second surface of the temporary lens obtained is greater than the radius of curvature of the center portion thereof, and molding a corrected lens under the condition applying the corrected pressing mold temperature;
subsequently molding the original lens under the condition applying the corrected pressing mold temperature when the irregularity of the corrected lens obtained falls within a permitted range; and
repeating the pressing mold temperature correction and molding of the corrected lens when the irregularity of the corrected lens obtained falls outside the permitted range until the irregularity of the corrected lens obtained falls within the permitted range.

4. A method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:
feeding a heated glass material between the molding surfaces of the preheated upper and lower pressing molds and cooling the upper and lower molds at prescribed cooling rates and press molding the glass material to obtain a temporary lens;
correcting by increasing the cooling rate of the mold forming the second surface or by decreasing the cooling rate of the mold forming the first surface when an irregularity is produced where the radius of curvature of the peripheral portion of the first or second surface of the temporary lens obtained is smaller than the radius of curvature of the center portion thereof, and molding a corrected lens under the condition applying the corrected cooling rate;
correcting by decreasing the cooling rate of the mold forming the second surface or by increasing the cooling rate of the mold forming the first surface when an irregularity is produced where the radius of curvature of the peripheral portion of the first or second surface of the temporary lens obtained is greater than the radius of curvature of the center portion thereof, and molding a corrected lens under the condition applying the corrected cooling rate;
subsequently molding the original lens under the condition applying the corrected cooling rate when the irregularity of the corrected lens obtained falls within a permitted range; and
repeating the correction of the cooling rate and molding of the corrected lens when the irregularity of the corrected lens obtained falls outside the permitted range until the irregularity of the corrected lens obtained falls within the permitted range.

5. A method of manufacturing a concave meniscus lens having a first surface comprising a convex surface shape and a second surface comprising a concave surface shape with a pair of upper and lower pressing molds having opposed molding surfaces by press molding a glass material in a heat-softened state; characterized by:
conducting press molding comprising feeding a heated glass material between the molding surfaces of the preheated upper and lower pressing molds and immediately applying pressure for a first time at a prescribed load, and once cooling has begun, applying pressure for a second time at a prescribed load smaller than that of the pressure application for the first time to obtain a temporary lens;
correcting by making the load of the second pressure application greater than the above prescribed load when an irregularity is produced where the radius of curvature of the peripheral portion of the first or second surface of the temporary lens obtained is smaller than the radius of curvature of the center portion thereof, and molding a corrected lens under the condition applying the corrected load;
correcting by making the load of the second pressure application smaller than the above prescribed load when an irregularity is produced where the radius of curvature of the peripheral portion of the first or second surface of the temporary lens obtained is greater than the radius of curvature of the center portion thereof, and molding a corrected lens under the condition applying the corrected load;
subsequently molding the original lens by applying the corrected load when the irregularity of the corrected lens obtained falls within a permitted range; and
repeating the load correction and molding of the corrected lens when the irregularity of the corrected lens obtained falls outside the permitted range until the irregularity of the corrected lens obtained falls within the permitted range.

6. The method of manufacturing according to claim 1, wherein the concave meniscus lens has a spherical surface on the first surface and the correction of molding condition is conducted by determining the irregularity of the first surface of the temporary lens obtained.

7. The method of manufacturing according to claim 2, wherein the concave meniscus lens has a spherical surface on the first surface and the correction of molding condition is conducted by determining the irregularity of the first surface of the temporary lens obtained.

8. The method of manufacturing according to claim 3, wherein the concave meniscus lens has a spherical surface on the first surface and the correction of molding condition is conducted by determining the irregularity of the first surface of the temporary lens obtained.

9. The method of manufacturing according to claim 4, wherein the concave meniscus lens has a spherical surface on the first surface and the correction of molding condition is conducted by determining the irregularity of the first surface of the temporary lens obtained.

10. The method of manufacturing according to claim 1, wherein the first or second surface of the concave meniscus lens has an aspherical surface.

11. The method of manufacturing according to claim 2, wherein the first or second surface of the concave meniscus lens has an aspherical surface.

12. The method of manufacturing according to claim 3, wherein the first or second surface of the concave meniscus lens has an aspherical surface.

13. The method of manufacturing according to claim 4, wherein the first or second surface of the concave meniscus lens has an aspherical surface.

14. The method of manufacturing according to claim 5, wherein the concave meniscus lens has a spherical surface on the first surface and the correction of molding condition is conducted by determining the irregularity of the first surface of the temporary lens obtained.

15. The method of manufacturing according to claim 5, wherein the first or second surface of the concave meniscus lens has an aspherical surface.
